(19) United States
(12) Patent Application Publication
(10) Pub. No.: US 2002/0146269 A1
(43) Pub. Date: Oct. 10, 2002

(54) Cross type supporter mounting system for a notebook computer keyboard and the method for mounting the same

(76) Inventors: Ming-Rong Wu, Taipei (TW); Chi-Hsiang Wang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/826,882

(22) Filed: Apr. 6, 2001

(51) Int. Cl. B41J 5/10

(52) U.S. Cl. 400/496

(57) ABSTRACT

A cross type supporter mounting system for a notebook computer keyboard comprises: a first platform for placing a computer keyboard and movable along an approximate horizontal direction; a second platform movable along a vertical direction and being positioned above the first platform; and a press plate installed between the first platform and the second platform. Thereby, by the pressure of the machining table with the operation of a press plate having a special pattern and cylinders, the last two steps in the assembling process is automatized. Therefore, the labor in the assembling process is reduced. Yield ratio is increased and the cost is decreased.

### FIELD OF THE INVENTION

The present invention relates to a cross type supporter mounting system for a notebook computer keyboard and the method for mounting the same, and especially to semi-auto cross type supporter mounting system for a notebook computer keyboard and the method of the same.

### BACKGROUND OF THE INVENTION

Referring to FIGS. 1 and 2, the key of a computer keyboard is formed by a cap 11, a touch moving elastomer 12, a first supporter 13, a second supporter 14 and a seat 15. The center at each of two sides of the first supporter 13 is installed with a respective pivotal shaft 16 and a pivotal hole 17 so that the first supporter 13 and second supporter 14 are pivotally connected as a cross type linking structure. The touch moving elatomer 12 is installed between the cap 11 and the seat 15 and is positioned in the travelling path of the cap 11. The lower ends of the two sides of the first supporter 13 and second supporter 14 are installed with respective pivotal shafts 18 and 19 pivotally connected to the through holes 20, 21 preset on the seat 15. The through holes 20 and 21 are installed with positioning pieces 22 and 23, respectively for confining the pivotal shafts 18 and 19 to move upwards. Besides, a spacer 24 is further installed at a lateral side of the second supporter 14. Thereby, as the first supporter 13 and second supporter 14 are placed into the through holes 20 and 21, the first supporter 13 and second supporter 14 are prevented from sliding out.

In assembling such a key structure, the most complex structure is the assembly of the first supporter 13 and the second supporter 14. In general, the operator needs to pivotally cross the first supporter 13 and second supporter 14. Then, the pivotal shaft 18 below the first supporter 13 is installed in a respective through hole 20. Then, an upper force is applied thereon so that the pivotal shaft 18 at the lower end of the second supporter 14 is pushed into a respective through hole 21, and then a horizontal outer force is applied the cross structure formed by the first supporter 13 and the second supporter 14 so that the second supporter 14 is stopped by the spacer 24 so as not to slide out of the structure.

In this method, it is often that the pivotal shaft 19 at lower end of the second supporter 14 is deformed by outer forces due to an improper applied force. Furthermore, since the volumes of the first supporter 13 and second supporter 14 are too small, manual assembly is not economical. Therefore, in practical assembly, it will induce a great inconvenience.

### SUMMARY OF THE INVENTION

Accordingly, the primary object of the present invention is to provide a cross type supporter mounting system for a notebook computer keyboard and the method for mounting the same, and especially to semi-auto cross type supporter mounting system for a notebook computer keyboard and the method of the same. Therefore, the labor in the assembling process is reduced. Yield ratio is increased and the cost is decreased.

To achieve the objects, the present invention provides a cross type supporter mounting system for a notebook computer keyboard comprising: a first platform for placing a computer keyboard and movable along an approximate horizontal direction; a second platform movable along a vertical direction and being positioned above the first platform; and a press plate installed between the first platform and the second platform. Thereby, by the pressure of the machining table with the operation of a press plate having a special pattern and cylinders, the last two steps in the assembling process is automatized. Therefore, the labor in the assembling process is reduced. Yield ratio is increased and the cost is decreased.

The various objects and advantages of the present invention will be more readily understood from the following detailed description when read in conjunction with the appended drawing.

### BRIEF DESCRIPTION OF THE DRAWINGS

FIG. 1 is a perspective view of a key of a prior art notebook computer keyboard.

FIG. 2 is plane view of a key of a prior art notebook computer keyboard.

FIG. 3A is a perspective view of the mounting system of the present invention.

FIG. 3B is a perspective view of the mounting system of the present invention viewing from another visual angle.

FIG. 4A is a front view of the mounting system of the present invention.

FIG. 4B is a lateral view of the mounting system of the present invention.

FIG. 5 is a perspective view showing the press plate of the present invention.

FIG. 6A is a lateral view of the cross type supporter in the present invention.

FIG. 6B is an upper view of the cross type supporter in the present invention.

FIG. 6C is a lateral view of the seat in the present invention.

FIG. 6D is an upper view of the seat in the present invention.

FIG. 7A˜7F is a schematic view showing the mounting system of the present invention.

FIG. 8 is a flow diagram of the mounting system in the present invention.

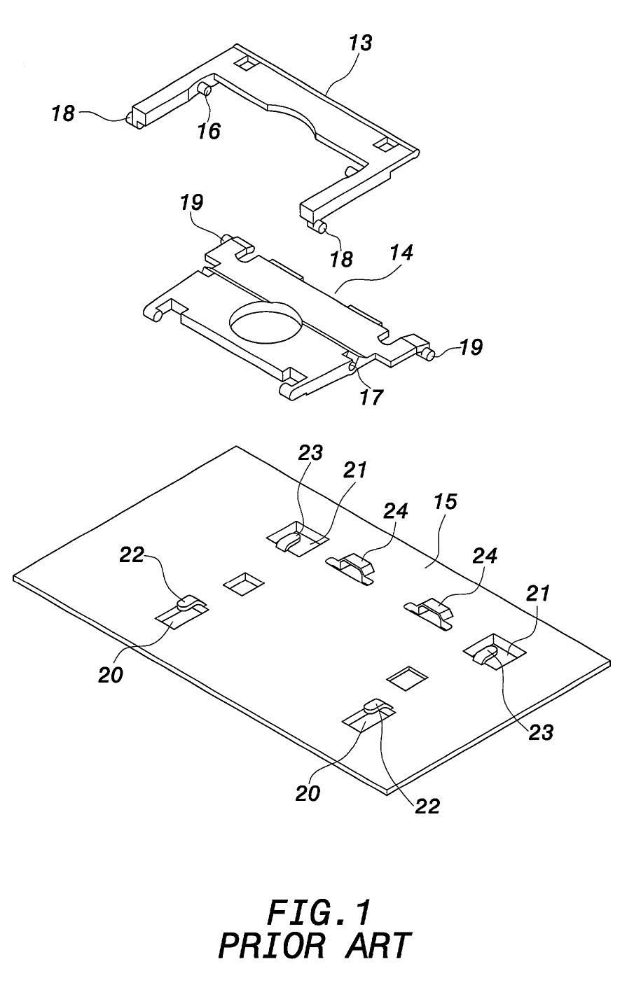

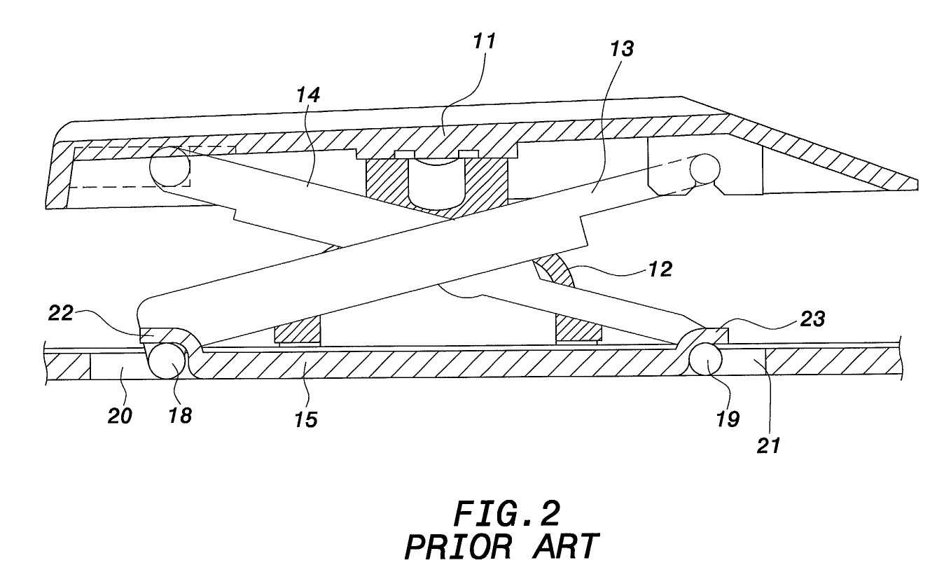

### DETAILED DESCRIPTION OF THE PREFERRED EMBODIMENTS

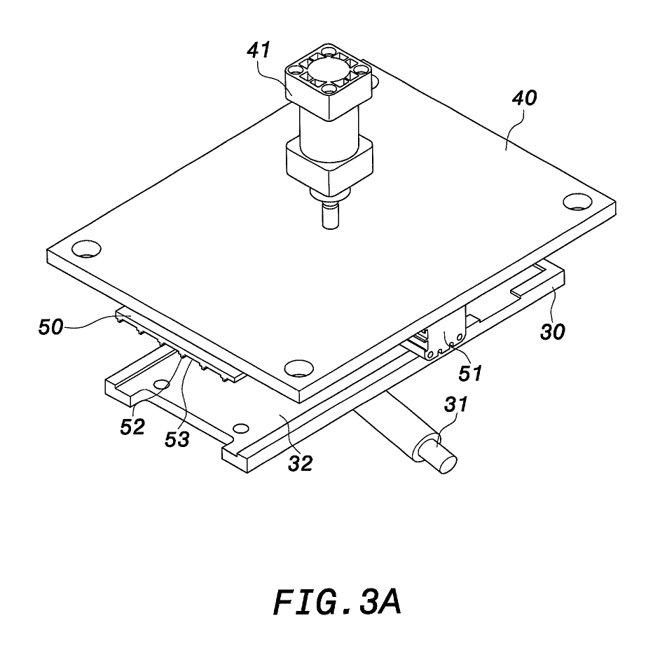

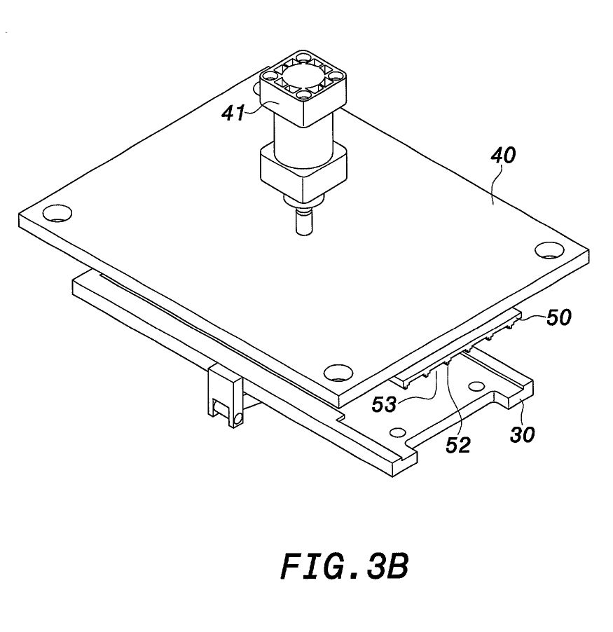

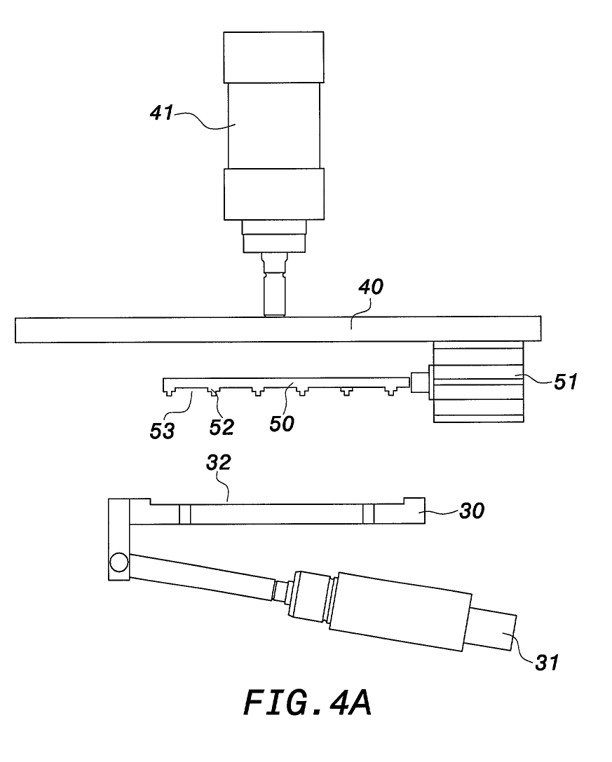

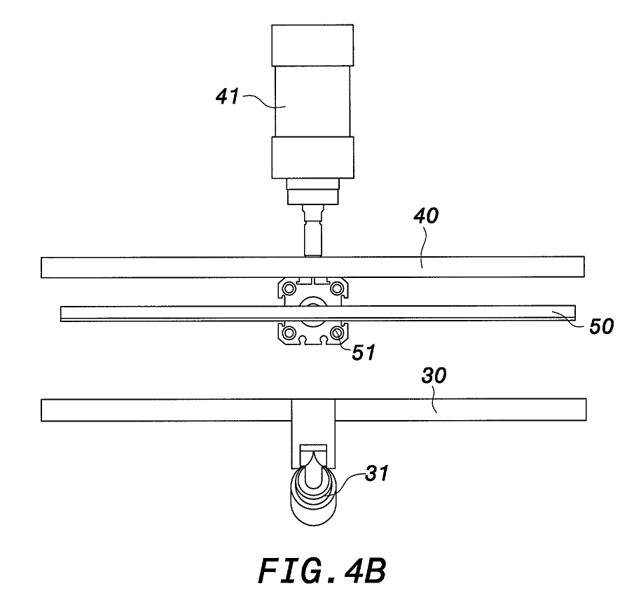

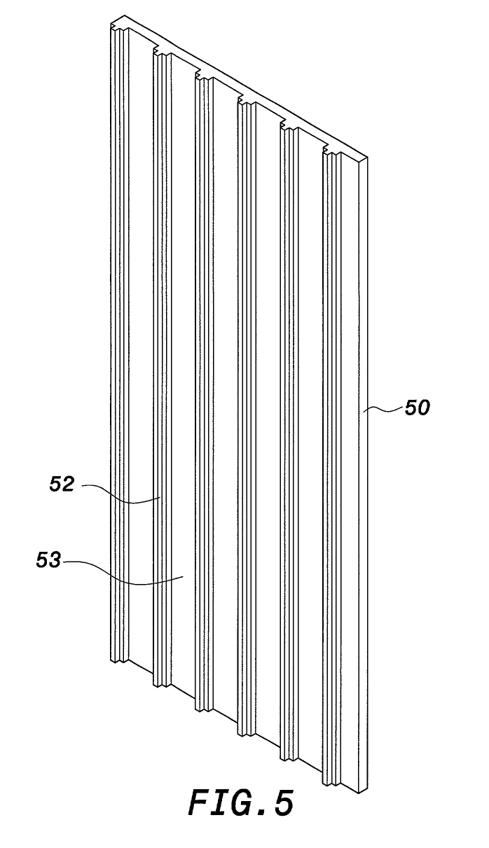

Referring to FIGS. 3A, 3B, 4A and 4B, the cross type supporter mounting system for a notebook computer keyboard of the present invention is illustrated. The cross type supporter mounting system of the present invention includes a first platform 30 movable along an approximate horizontal direction, a second platform 40 movable along a vertical direction, and a press plate 50 having a special pattern and movable along a horizontal direction. The first platform 30 is movably installed in the system and is connected with a feeding cylinder 31. The feeding cylinder 31 is properly fixed in the system. The first platform 30 can be driven along an approximate horizontal direction by the feeding cylinder 31. A placing surface 32 is formed at a top of the first platform 30 for placing a computer keyboard to be mounted. The second platform 40 is movably installed in the system and is above the first platform 30 with a proper height, and further, is connected with a press cylinder 41. The press cylinder 41 is properly fixed to the system. The second platform 40 can be driven by the pull cylinder 41 to move along a vertical direction. The press plate 51 is movably installed between the first platform 30 ad the second platform 40 and is connected to a pull cylinder 51. The pull cylinder 51 is properly fixed to the bottom of the second platform 40. The press plate 50 can be driven by the pull cylinder 51 to move along a horizontal direction. The bottom of the press plate 50 is installed with a plurality of protrusions 52 having a ladder shape (see FIG. 5). A recess 52 is formed between two protrusions 52 for receiving a cross type supporter. Therefore, by aforesaid components, a cross type supporter mounting system for a notebook computer keyboard of the present invention is formed.

In this the present invention, the movement of the first platform 30, second platform 40, and press plate 50 are achieved through three cylinders 31, 41, and 51. Of course, the cylinders may be oil pressure cylinders or other types.

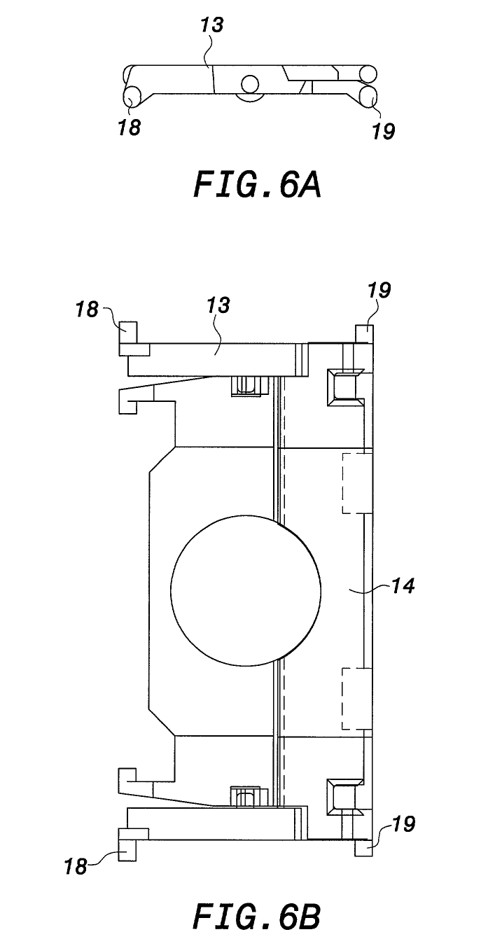

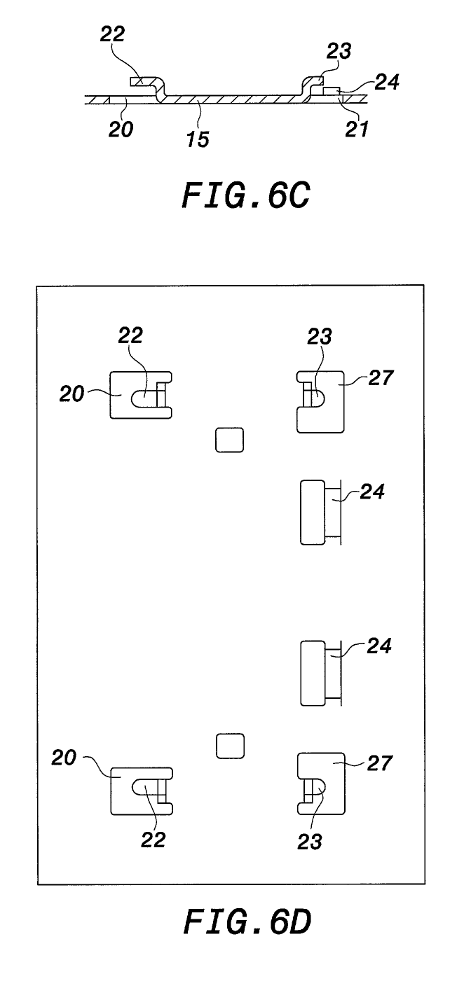

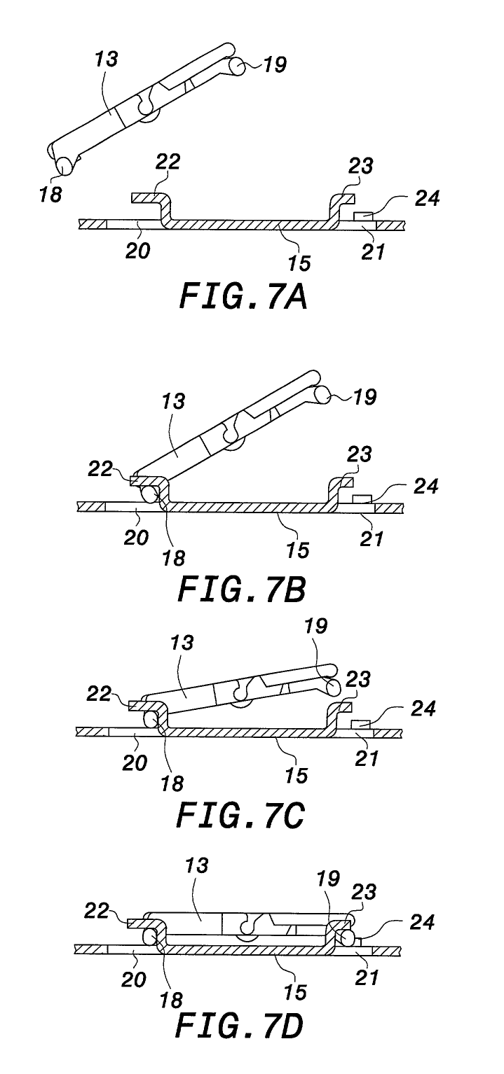

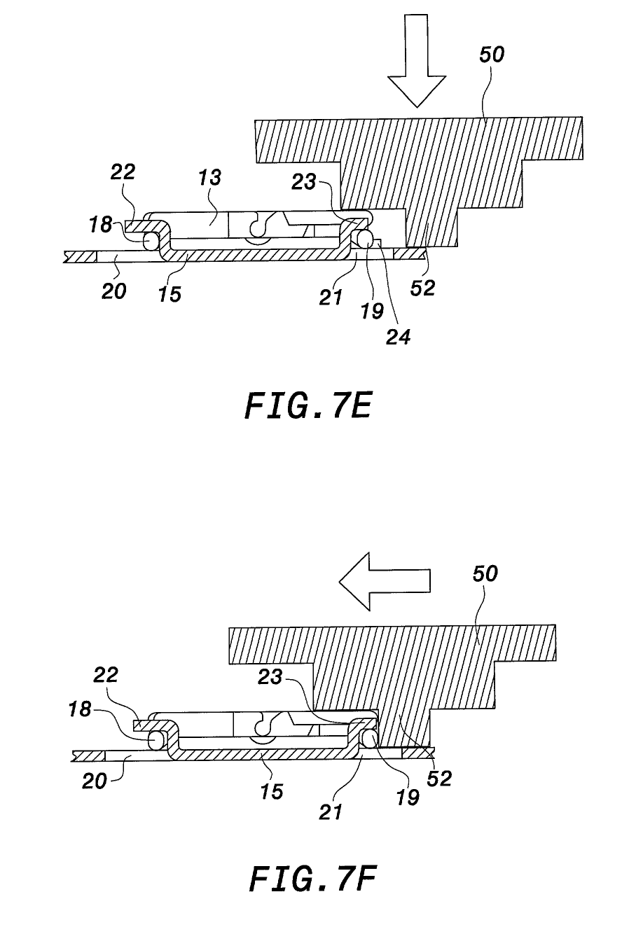

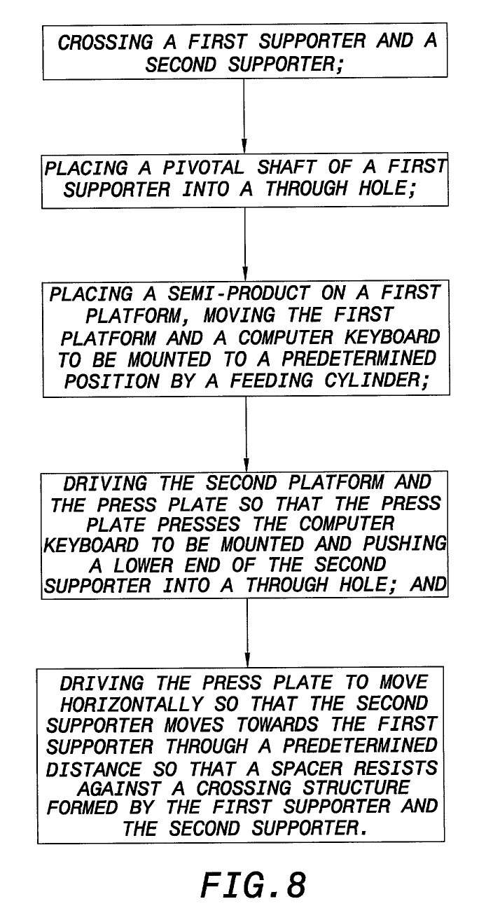

With reference to FIGS. 6A-6D, the cross type supporter and seat of the present invention and other related drawings are illustrated. Further, referring to FIGS. 7A-7D, and FIG. 8, the mounting system and operating steps of the present invention are illustrated. The process of the present invention includes the steps of:

(1) at first, crossing the first supporter 13 and second supporter 14 (referring to FIG. 7A);

(2) then, placing the pivotal shaft 18 of the first supporter 13 into the through hole 20 (referring to FIG. 7B);

(3) then, placing a semi-product on the first platform 30, moving the first platform 30 and a computer keyboard to be mounted to a predetermined position by the feeding cylinder 31;

(4) next, driving the second platform 40 and the press plate 50 by the pressing cylinder 41 so that the press plate 50 presses the computer keyboard to be mounted and a lower end of the second supporter 14 is pushed into a through hole 21 (referring to FIGS. 7C and 7D);

(5) next, the pull cylinder 51 driving the press plate 50 to move horizontally so that the second supporter 14 moves towards the first supporter 13 through a predetermined distance (referring to FIGS. 7E and 7F) so that a spacer 24 resists against the crossing structure formed by the first supporter 13 and the second supporter 14.

The present invention provides a semi-automatic cross type supporter mounting system for a notebook computer keyboard and the method for mounting the same. In the present invention, the pressure of the machining table with the operation of a press plate having a special pattern and cylinders, the last two steps in the assembling process are automatized. Therefore, the labor in the assembling process is reduced. Yield ratio is increased and the cost is decreased.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A cross type supporter mounting system for a notebook computer keyboard comprising:
a first platform for placing a computer keyboard and movable along an approximate horizontal direction;
a second platform movable along a vertical direction and being positioned above the first platform; and
a press plate installed between the first platform and the second platform.

2. The cross type supporter mounting system for a notebook computer keyboard as claimed in claim 1, wherein the first platform is connected to a feeding cylinder; the first supporter is driven to move along an approximate horizontal direction by the feeding cylinder.

3. The cross type supporter mounting system for a notebook computer keyboard as claimed in claim 1, wherein a top of the first platform is formed with a placing surface for placing a computer keyboard.

4. The cross type supporter mounting system for a notebook computer keyboard as claimed in claim 1, wherein the second platform is connected to a pull cylinder for driving the pressing cylinder to move vertically.

5. The cross type supporter mounting system for a notebook computer keyboard as claimed in claim 1, wherein the press plate is connected to a pull cylinder for driving the press plate to move horizontally.

6. The cross type supporter mounting system for a notebook computer keyboard as claimed in claim 1, wherein a bottom of the press plate is installed with a plurality of protrusions having a ladder-like shape.

7. A method for mounting a cross type supporter for a notebook computer keyboard comprising the steps of:
(1) at first, crossing a first supporter and a second supporter;
(2) then, placing a pivotal shaft of a first supporter into a through hole;
(3) then, placing a semi-product from steps (2) on a first platform, moving the first platform and a computer keyboard to be mounted to a predetermined position by a feeding cylinder;
(4) next, driving the second platform and the press plate so that the press plate presses the computer keyboard to be mounted and pushing a lower end of the second supporter into a through hole; and
(5) next, driving the press plate to move horizontally so that the second supporter moves towards the first supporter through a predetermined distance, and thus a spacer resisting against a crossing structure formed by the first supporter and the second supporter.

8. The method for mounting a cross type supporter for a notebook computer keyboard as claimed in claim 7, wherein the first platform, second platform and press plate are driven by a cylinder.
